(19) United States
(12) Patent Application Publication
(10) Pub. No.: US 2024/0126245 A1
(43) Pub. Date: Apr. 18, 2024

(54) CAPACITY PLANNING FOR EFFICIENT RESOURCE UTILIZATION

(71) Applicant: International Business Machines Corporation, Armonk, NY (US)

(72) Inventors: Shailendra Moyal, Pune (IN); Sarbajit K. Rakshit, Kolkata (IN); Akash U. Dhoot, Pune (IN); Shilpa Bhagwatprasad Mittal, Pune (IN)

(21) Appl. No.: 17/964,173

(22) Filed: Oct. 12, 2022

(51) Int. Cl. G05B 19/418

(52) U.S. Cl. CPC G05B 19/41865; G05B 2219/32365

(57) ABSTRACT

A computer-implemented method, system and computer program product for efficient resource utilization. A workflow of manufacturing a product using various machines at each plant of an organization is created, where the workflow illustrates which machines are utilized to produce the product using one or more raw materials. A production rate for the product at each plant manufacturing the product is predicted based on the workflow. An amount of a raw material required by a first plant to produce the product is determined based on the predicted production rate for the product at the first plant. An amount of the raw material is then routed to the first plant from one or more other plants based on minimizing the system inventory carrying cost and minimizing the system transportation cost if the first plant needs an additional amount of the raw material to realize the predicted production rate for the product.

### TECHNICAL FIELD

The present disclosure relates generally to capacity planning software, and more particularly to ensuring efficient resource utilization using capacity planning.

### BACKGROUND

Capacity planning software is a programmable solution that helps manufacturing organizations understand the actual production capacity needed to address fluctuating demands for its products and services. Furthermore, capacity planning software helps companies compare production loads with available capacity within a specific time frame. The process of planning for capacity helps avoid bottlenecks in production which can impact the entire supply chain.

### SUMMARY

In one embodiment of the present disclosure, a computer-implemented method for efficient resource utilization using capacity planning comprises creating a workflow of manufacturing a product using various machines at each plant of an organization, where the workflow illustrates which machines are utilized to produce the product using one or more raw materials. The method further comprises predicting a production rate for the product at each plant of the organization manufacturing the product based on the workflow, where the production rate corresponds to a volume of units of the product to be manufactured during a time frame. The method additionally comprises determining an amount of a first raw material required by a first plant to produce the product over the time frame based on a first predicted production rate for the product at the first plant. Furthermore, the method comprises routing an amount of the first raw material to the first plant from one or more other plants based on minimizing system inventory carrying cost and minimizing system transportation cost in response to the first plant needing an additional amount of the first raw material to realize the first predicted production rate for the product.

Other forms of the embodiment of the computer-implemented method described above are in a system and in a computer program product.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates a communication system for practicing the principles of the present disclosure in accordance with an embodiment of the present disclosure;

FIG. 2 is a diagram of the software components used by the raw material distributor system to ensure that the plants have the required raw materials to manufacture products while minimizing the system inventory carrying cost and the system transportation cost in accordance with an embodiment of the present disclosure;

FIG. 3 illustrates an embodiment of the present disclosure of the hardware configuration of the raw material distributor system which is representative of a hardware environment for practicing the present disclosure;

FIG. 4 is a flowchart of a method for ensuring that a plant has the required amount of raw material to realize the production rate for a product while minimizing system inventory carrying cost and minimizing system transportation cost in accordance with an embodiment of the present disclosure;

FIG. 5 is a flowchart of a method for selecting the amount of raw material to be transported to the plant in need of additional raw material and the route for such transportation in accordance with an embodiment of the present disclosure;

FIG. 6 is a flowchart of a method for updating the route or altering the amount of raw material to be transported in response to feedback provided by Internet of Things (IoT) sensors in accordance with an embodiment of the present disclosure; and

FIG. 7 is a flowchart of a method for updating the route or altering the amount of raw material to be transported in response to changes in the predicted production rate in accordance with an embodiment of the present disclosure.

### DETAILED DESCRIPTION

As stated in the Background section, capacity planning software is a programmable solution that helps manufacturing organizations understand the actual production capacity needed to address fluctuating demands for its products and services. Furthermore, capacity planning software helps companies compare production loads with available capacity within a specific time frame. The process of planning for capacity helps avoid bottlenecks in production which can impact the entire supply chain.

Organizations may utilize multiple manufacturing plants to manufacture a product. A manufacturing plant (also referred to as a “production plant” or simply a “plant”) is an industrial facility, often a complex consisting of several buildings filled with machinery, whose workers manufacture items or operate machines which process each item into another.

Such plants, at times, may have excess or a shortage amount of raw materials that are required in the production process. A raw material, also known as a feedstock, unprocessed material, or primary commodity, is a basic material that is used to produce goods, finished goods, energy, or intermediate materials that are feedstock for future finished products. A raw material is a material in an unprocessed or minimally processed state, such as raw latex, crude oil, cotton, coal, raw biomass, iron ore, air, logs, water or any product of agriculture, forestry, fishing or mineral in its natural form or which has undergone the transformation required to prepare it for marketing in substantial volumes.

When plants have an excess or a shortage amount of raw materials, capacity planning software may utilize such information in an attempt to ensure that each plant in the organization has an adequate amount of raw materials to produce the required amount of products.

Unfortunately, such capacity planning software tools fail to ensure that each plant in the organization has the required minimum amount of raw materials needed to produce the required amount of products while minimizing the organization's inventory carrying cost. “Inventory carrying cost,” as used herein, refers to the expenses that arise from keeping raw materials at the plant, such as being shelved at the plant. Neither do such software tools consider transportation cost, such as the cost for distributing the raw materials to the various plants, including from one plant to another plant. As a result, such capacity planning tools are deficient in meeting the organization's plant capacity needs while minimizing cost, such as the organization's inventory carrying cost and the organization's transportation cost.

The embodiments of the present disclosure provide a means for meeting the organization's plant capacity needs by ensuring that a plant has the required amount of raw material to realize its production rate for a product while minimizing the system inventory carrying cost and minimizing the system transportation cost as discussed in further detail below.

In some embodiments of the present disclosure, the present disclosure comprises a computer-implemented method, system and computer program product for managing raw material distribution. In one embodiment of the present disclosure, a workflow of manufacturing a product using various machines at each plant of an organization is created, where the workflow illustrates which machines are utilized to produce the product using one or more raw materials. In one embodiment, such a workflow is based on feedback received from Internet of Things (IoT) sensors monitoring the raw material (e.g., lumber) that is used to manufacture a product (e.g., table) using a series of machines (e.g., single multi-purpose machine that is able to joint, plane and edge in a single pass, table saw, computer numerical control (CNC) router, sander and finishing booth). A production rate for the product at each plant of the organization manufacturing the product is predicted based on the workflow, where the production rate corresponds to a volume of units of the product to be manufactured during a time frame. An amount of a first raw material (e.g., biomass) required by a first plant to produce the product (e.g., food additive) is determined based on the predicted production rate for the product at the first plant. An amount of the first raw material is then routed to the first plant from one or more other plants based on minimizing the system inventory carrying cost and minimizing the system transportation cost if the first plant needs an additional amount of the first raw material to realize the predicted production rate for the product. In this manner, the organization's plant capacity needs are met by ensuring that a plant has the required amount of raw material to realize its production rate for a product while minimizing the system inventory carrying cost and minimizing the system transportation cost.

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill in the relevant art.

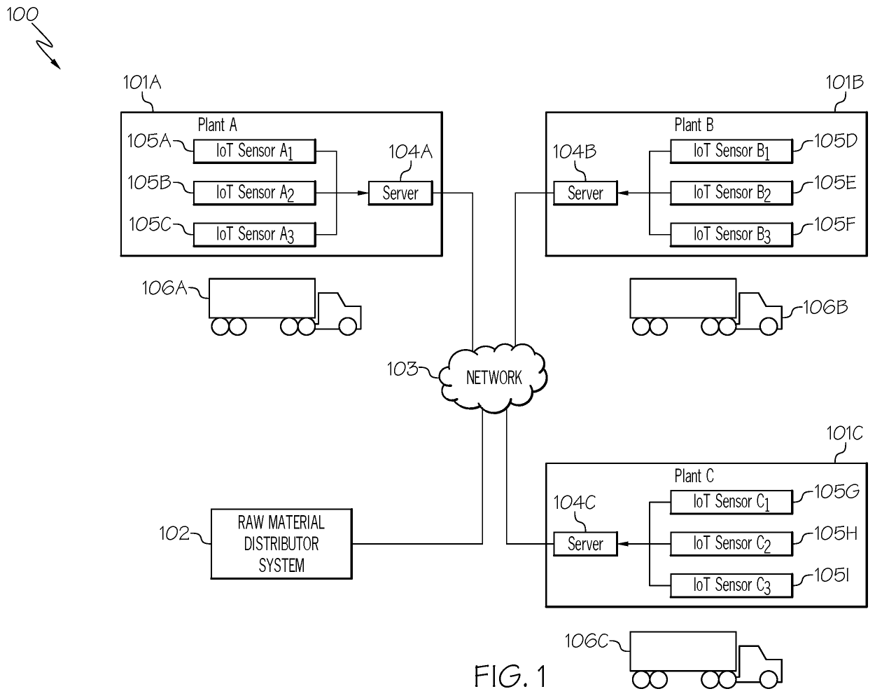

Referring now to the Figures in detail, FIG. 1 illustrates an embodiment of the present disclosure of a communication system 100 for practicing the principles of the present disclosure. Communication system 100 includes plants 101A-101C (identified as “Plant A,” “Plant B,” and “Plant C,” respectively in FIG. 1) connected to a raw material distributor system 102 via network 103. Plants 101A-101C may collectively or individually be referred to as plants 101 or plant 101, respectively.

A “plant” 101, as used herein, refers to a manufacturing plant, which is an industrial facility, often a complex consisting of several buildings filled with machinery, whose workers manufacture items or operate machines which process each item into another. In the illustration of FIG. 1, the interconnection of plants 101 to raw material distributor system 102 via network 103 is accomplished via computing devices of plants 101, such as servers 104A-104C in plants 101A-101C, respectively. Servers 104A-104C may collectively or individually be referred to as servers 104 or server 104, respectively.

In one embodiment, servers 104 are configured to obtain current raw material usage, workflow between machines, location information of transportation vehicles, amount of raw material being transported on a transportation vehicle, etc. at plant 101 from Internet of Things (IoT) sensors. For example, server 104A obtains such information from IoT sensors 105A-105C (identified as IoT sensor A₁ 105A, IoT sensor A₂ 105B and IoT sensor A₃ 105C, respectively, in FIG. 1). Server 104B obtains such information from IoT sensors 105D-105F (identified as IoT sensor B₁ 105D, IoT sensor B₂ 105E and IoT sensor B₃ 105F, respectively, in FIG. 1). Server 104C obtains such information from IoT sensors 105G-105I (identified as IoT sensor C₁ 105G, IoT sensor C₂ 105H and IoT sensor C₃ 105I, respectively, in FIG. 1). IoT sensors 105A-105I may collectively or individually be referred to as IoT sensors 105 or IoT sensor 105, respectively. While FIG. 1 illustrates each plant 101 utilizing three IoT sensors 105, it is noted that each plant 101 may utilize any number of IoT sensors 105.

IoT sensor 105, as used herein, refers to a sensor that can be attached to a container (e.g., container of raw materials) or a physical object (e.g., machine, raw materials, transportation vehicle) or groups of such objects that connect and exchange data with other devices and systems over a network, such as network 103. In one embodiment, IoT sensors 105 are configured to monitor and/or control industrial equipment (machines) at plant 101. In one embodiment, IoT sensors 105 are utilized to improve efficiency of plant operations by providing detailed data on all aspects of the plant's operations.

Furthermore, such IoT sensors 105 may be utilized to monitor transportation vehicles, such as transportation vehicles 106A-106C, including raw material being transported by such transportation vehicles 106A-106C. Transportation vehicles 106A-106C may collectively or individually be referred to as transportation vehicles 106 or transportation vehicle 106, respectively. Transportation vehicle 106, as used herein, refers to a cargo-carrying vehicle, such as an automobile, van, tractor, truck, semitrailer, etc. for the transportation of cargo, such as raw materials. While FIG. 1 illustrates three transportation vehicles 106, there may be any number of transportation vehicles 106 that are utilized in system 100 for transporting raw materials to and/or from plants 101 as discussed further below.

Furthermore, in one embodiment, IoT sensors 105 may provide information regarding the current weather conditions, road conditions, vehicle conditions and route details. For example, IoT sensors 105 may be implemented in a weather monitoring system (not shown in FIG. 1) in which IoT sensors 105 measure the physical parameters of a certain location (e.g., light, temperature, wind, moisture, pressure, etc.) and provide such details to raw material distributor system 102 via server 104, whether directly or indirectly, such as by uploading them in real-time to cloud storage, where the data can be analyzed immediately, such as by raw material distributor system 102.

In another example, IoT sensors 105 may be utilized in a traffic management system (not shown in FIG. 1) (e.g., IoT sensors 105 are placed on roads, highways, etc.) to monitor, analyze and share traffic data, such as traffic congestion, accidents, etc. Such information may be used to provide information regarding road conditions and route details. For instance, such information may be provided to raw material distributor system 102 via server 104, where raw material distributor system 102 could use such information to determine optimal routes based on accidents, traffic jams, etc. using various software tools, such as Waze, etc.

In another example, IoT sensors 105 may be utilized in vehicles (not shown), such as transportation vehicles 106, to constantly monitor vehicle conditions. For example, such IoT sensors 105 may gather real-time data on fuel consumption, engine temperature, fluid levels, etc. Such information may be provided to raw material distributor system 102 via server 104 to detect pre-failure conditions prior to failures thereby avoiding unnecessary expenses. When such issues require maintenance, raw material distributor system 102 may update a route or alter the amount of raw material being transported by transportation vehicle 106 as discussed further below.

In one embodiment, such IoT sensors 105 may be used to provide location information of transportation vehicles 106, amount of raw material being transported on transportation vehicle 106, etc.

As discussed above, transportation vehicles 106 transport cargo, such as raw materials. A “raw material” (also referred to as a feedstock, unprocessed material or primary commodity), as used herein, refers to a basic material that is used to produce goods, finished goods, energy or intermediate materials that are feedstock for future finished products. A raw material is a material in an unprocessed or minimally processed state, such as raw latex, crude oil, cotton, coal, raw biomass, iron ore, air, logs, water, spare parts or any product of agriculture, forestry, fishing or mineral in its natural form or which has undergone the transformation required to prepare it for marketing in substantial volumes.

As discussed above, system 100 includes a raw material distributor system 102. In one embodiment, raw distributor system 102 is configured to ensure that plants 101 have the required raw material to manufacture products while minimizing the system inventory carrying cost and the system transportation cost.

In one embodiment, raw material distributor system 102 determines a required amount of raw material (e.g., biomass) to manufacture a product (e.g., food additive) by plant 101 over a time frame based on a predicted production rate for the product at plant 101. In one embodiment, such a predicted production rate is based on a workflow between machines at plant 101 that are utilized for manufacturing the product (e.g., food additive).

In one embodiment, raw material distributor system 102 is configured to route an amount of the raw material (e.g., biomass) from one plant 101 (e.g., plant 101B) to another plant 101 (e.g., plant 101A) in situations where one of the plants 101 (e.g., plant 101A) needs an additional amount of the raw material (e.g., biomass) to realize the production rate for the product (e.g., food additive) where the other plant 101 (e.g., plant 101B) has an excess amount of that raw material (e.g., biomass). In one embodiment, the amount of raw material that is routed from one plant 101 to another plant 101 is based on minimizing the system inventory carrying cost and minimizing the system transportation cost. “Inventory carrying cost,” as used herein, refers to the expenses that arise from keeping raw materials at the plant, such as being shelved at the plant. “System inventory carrying cost,” as used herein, refers to the inventory carrying cost of system 100 across all plants 101. “Transportation cost,” as used herein, refers to the expense of transporting cargo, such as raw materials, by transportation vehicle 106. Such an expense includes fuel, vehicle maintenance costs, wear and tear, parking fees as well as lodging, meals and telephone charges incurred by employees of the organization, such as the drivers of transportation vehicles 106. “System transportation cost,” as used herein, refers to the transportation cost of all vehicles 106 utilized by system 100.

In one embodiment, raw material distributor system 102 is configured to select a route for transporting a raw material (e.g., biomass), such as from plant 101B to plant 101A, out of multiple simulated routes based on minimizing transportation cost.

In one embodiment, raw material distributor system 102 is configured to update the route or alter the amount of raw material to be provided by transportation vehicle 106 based on feedback received from IoT sensors 105, such as updating a route due to a traffic accident, as discussed further below.

In one embodiment, raw material distributor system 102 is configured to detect a change in the predicted production rate of a product. In response to detecting such a change, the transportation route of transportation vehicle 106 delivering the raw material to plant 101 that is used to manufacture such a product may be updated or the amount of raw material to be provided to plant 101 may be altered while ensuring that the system inventory carrying cost and the system transportation cost are minimized.

A more detailed description of these and other features is provided below.

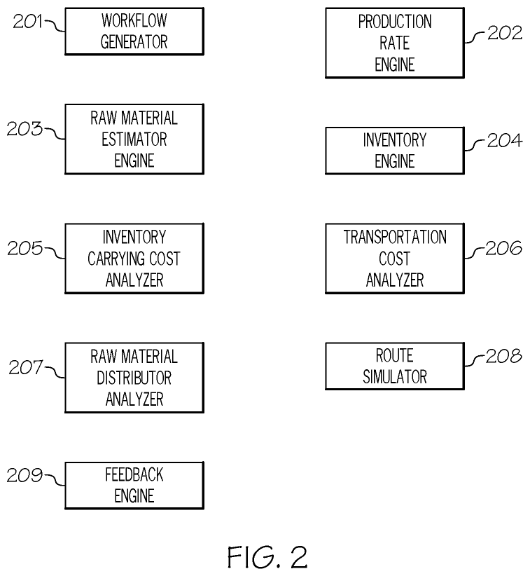

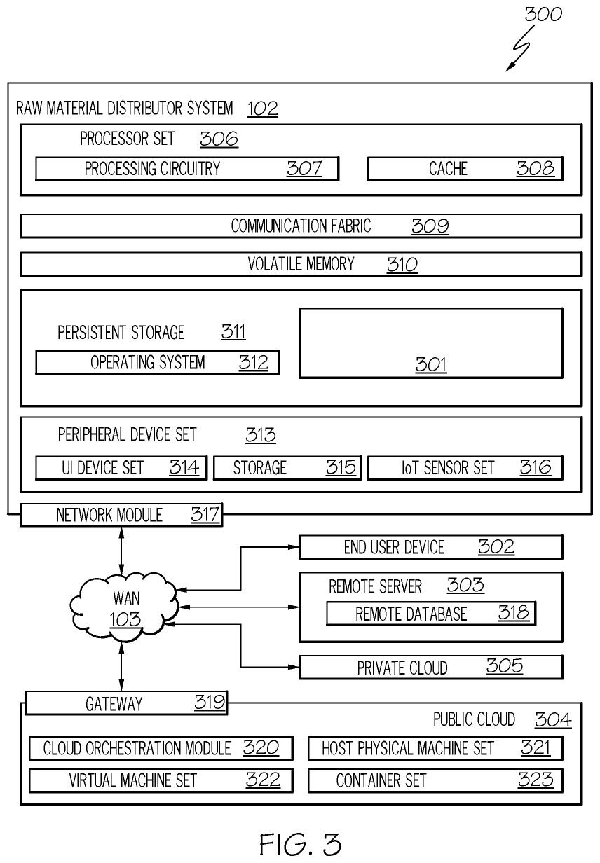

A description of the software components of raw material distributor system 102 used for ensuring that plants 101 have the required raw materials to manufacture products while minimizing the system inventory carrying cost and the system transportation cost is provided below in connection with FIG. 2. A description of the hardware configuration of raw material distributor system 102 is provided further below in connection with FIG. 3.

System 100 is not to be limited in scope to any one particular network architecture. System 100 may include any number of plants 101, raw material distributor systems 102, networks 103, servers 104, IoT sensors 105 and transportation vehicles 106.

A discussion regarding the software components used by raw material distributor system 102 to ensure that plants 101 have the required raw materials to manufacture products while minimizing the system inventory carrying cost and the system transportation cost is provided below in connection with FIG. 2

FIG. 2 is a diagram of the software components used by raw material distributor system 102 to ensure that plants 101 have the required raw materials to manufacture products while minimizing the system inventory carrying cost and the system transportation cost in accordance with an embodiment of the present disclosure.

Referring to FIG. 2, in conjunction with FIG. 1, raw material distributor system 102 includes a workflow generator 201 configured to create a workflow of manufacturing a product using various machines at each plant 101 of an organization, where the workflow illustrates which machines are being utilized to produce the product (e.g., food additive) using one or more raw materials (e.g., biomass). A “workflow,” as used herein, refers to a sequence of machines being utilized to manufacture a product from initiation to completion using one or more raw materials. In one embodiment, workflow generator 201 generates such a workflow based on feedback received from IoT sensors 105 monitoring the raw material (e.g., lumber) that is used to manufacture a product (e.g., table) using a series of machines (e.g., single multi-purpose machine that is able to joint, plane and edge in a single pass, table saw, computer numerical control (CNC) router, sander and finishing booth). For example, IoT sensors 105 may monitor the raw material (e.g., lumber) that is first passed to a single multi-purpose machine that is able to joint, plane and edge in a single pass. Jointers take the warp and bend out of the bottom of the board so that it will lie flat when it goes through the planer. Planers flatten the top of the board and cut it down to the desired thickness. Edgers take the rough wood and any warp or bend off the sides of the board. The next step is to cut across the board using a table saw according to a user-designated specification followed by utilizing the computer numerical control (CNC) router to cut coves, mortises and slots as well as various shaping tasks. In one embodiment, the desired shape is entered into a computer and the CNC router is then robotically manipulated by the machine. Afterwards, the wooden panel is fed through stationary sanders made of rotating belt(s) with a feed table beneath them. Such a sander is used to sand the surfaces of the wood and to smooth out glue joints. Lastly, protective finishes, such as polyurethane, are sprayed onto the furniture as a final step in its manufacture at a finishing booth.

In one embodiment, IoT sensors 105 monitor the sequence of machines (e.g., single multi-purpose machine that is able to joint, plane and edge in a single pass, table saw, computer numerical control (CNC) router, sander and finishing booth) being utilized to manufacture a product (e.g., table) from initiation to completion using raw material (e.g., lumber) by placing such IoT sensors 105 on or near the raw material and machines.

In one embodiment, such workflows include metadata, which includes timing information, such as the duration of time to complete each task in the manufacturing process. For example, during the manufacturing of a table, the workflow may include metadata, which includes the timing information for completing each step performed by the machines of a single multi-purpose machine that is able to joint, plane and edge in a single pass, a table saw, a computer numerical control (CNC) router, a sander and a finishing booth. In one embodiment, such timing information may be obtained from IoT sensors 105 monitoring such machines which may time the task performed by such machines from initiation to completion.

In one embodiment, such metadata further includes the amount of raw material that was used to produce the product in the manufacturing process. For example, such metadata may include the amount of 8 kilograms of lithium that is needed to make a single lithium-ion battery pack for a single electric car. In one embodiment, such information may be obtained from IoT sensors 105 monitoring the amount of raw material being used to manufacture a product (e.g., lithium-ion battery pack). In one embodiment, such metadata is provided by an expert, who inputs such information in raw material distributor system 102.

In one embodiment, such workflows, including the associated metadata, are stored in a storage device (e.g., memory, disk unit) of raw material distributor system 102.

In one embodiment, workflow generator 201 creates such a workflow based on feedback provided by IoT sensors 105 discussed above using various software tools, including, but not limited to, nTask®, Automate.io, ClickUp®, KissFlow®, Hive®, etc.

Raw material distributor system 102 further includes a production rate engine 202 configured to predict the production rate for a product (e.g., table) for each plant 101 (e.g., plant 101A, 101B, 101C) manufacturing the product based on the workflow (workflow for manufacturing the product using machines at the plant) that was created by workflow generator 201. The “production rate,” as used herein, refers to the volume or number of units of a product (e.g., table, food additive) that can be produced during a given period of time (e.g., ten hours).

In one embodiment, the current production rate is determined by production rate engine 202 utilizing the metadata associated with the workflow. For example, it may take a total of 3 hours to manufacture a table using the machines discussed above from initiation until completion. As a result, the production rate is 3 tables over a 9 hour period of time. In one embodiment, the period of time upon which the production rate is based is user-designated.

In one embodiment, production rate engine 202 is configured to predict a future production rate using past production rates. For example, the past production rates for a product at plant 101 over a one month period of time may be utilized for predicting the production rate of the product over the next two days. Such a prediction may be performed by production rate engine 202 using time series analysis or causal modeling. In one embodiment, such a prediction is performed by production rate engine 202 using the moving average method in which a range of data points is created based on a series of averages from the full data set (e.g., past production rates for a product over the past month). In one embodiment, such a prediction is performed by production rate engine 202 using the trend projection method in which the past trends are assumed to continue in the future at roughly the same rate.

In one embodiment, production rate engine 202 predicts the future production rate using a machine learning model configured to predict the future production rate of a product by plant 101.

In one embodiment, production rate engine 202 trains a model to predict the future production rate of a product by plant 101 based on the past production rate of manufacturing the product by a particular plant 101.

In one embodiment, production rate engine 202 uses a machine learning algorithm (e.g., supervised learning) to build the model to predict the future production rate of a product by plant 101 using a sample data set containing past production rates for the product by the plant in question.

Such a sample data set is referred to herein as the “training data,” which is used by the machine learning algorithm to make predictions or decisions as to the future production rate of the product by plant 101. The algorithm iteratively makes predictions on the training data as to the future production rate of the product by plant 101 until the predictions achieve the desired accuracy as determined by an expert. Examples of such learning algorithms include nearest neighbor, Naïve Bayes, decision trees, linear regression, support vector machines and neural networks.

Raw material distributor system 102 further includes a raw material estimator engine 203 configured to determine an amount of raw material (e.g., biomass) required by plant 101 (e.g., plant 101A) to produce the product (e.g., food additive) over a time frame, which may be user-designated, based on the predicted production rate for the product at plant 101 (e.g., plant 101A).

In one embodiment, raw material estimator engine 203 determines such an amount based on metadata associated with the workflow generated by workflow generator 201 as discussed above. As stated above, the metadata associated with the workflow created by workflow generator 201 may include the amount of raw material that was used to produce the product in the manufacturing process. For example, such metadata may include the amount of 8 kilograms of lithium that is needed to make a single lithium-ion battery pack.

After obtaining such information, raw material estimator engine 203 estimates the total amount of raw material needed to realize the production rate of the product at plant 101 (e.g., plant 101A). For example, if plant 101 is predicted to have a production rate of 1,000 lithium-ion battery packs over the next 9 hours, and the metadata indicates that 8 kilograms of lithium is needed to make a single lithium-ion battery pack, then raw material estimator engine 203 may determine, based on such information, that an amount of 8,000 kilograms of lithium is needed to realize the production rate of 1,000 lithium-ion battery packs over the next 9 hours.

In one embodiment, raw material estimator engine 203 uses various software tools for determining the amount of raw material (e.g., biomass) required by plant 101 (e.g., plant 101A) to produce the product (e.g., food additive) over a time frame, including, but not limited to, Fishbowl®, NetSuite®, Striven®, Katana Manufacturing ERP, QT9® ERP, etc.

Raw material distributor system 102 additionally includes an inventory engine 204 configured to determine the available amount of raw material (e.g., lithium) for plant 101 (e.g., plant 101A). In one embodiment, inventory engine 204 determines the available amount of raw material based on the information provided by IoT sensors 105 which indicates the amount of raw material that is currently available to be utilized by plant 105. For example, such IoT sensors 105 may be placed at or near the raw material (e.g., lithium) and keep track of the amount of raw material being utilized by the machines in the manufacturing process at plant 101 (e.g., plant 101A).

In one embodiment, inventory engine 204 uses various software tools to determine the current available amount of raw material (e.g., lithium) at plant 101 (e.g., plant 101A) using the information provided by IoT sensors 105 (e.g., amount of raw material being utilized by machines at plant 101), including, but not limited to, Fishbowl®, NetSuite®, Striven®, Katana Manufacturing ERP, QT9® ERP, etc.

Furthermore, raw material distributor system 102 includes inventory carrying cost analyzer 205 configured to determine the inventory carrying cost for carrying the raw material (e.g., lithium) for each plant 101 carrying such raw material, such as those plants 101 with an excess amount of the raw material in question (e.g., lithium). “Inventory carrying cost,” as used herein, refers to the expenses that arise from keeping raw materials at the plant, such as being shelved at the plant. “System inventory carrying cost,” as used herein, refers to the inventory carrying cost of system 100 across all plants 101.

In one embodiment, inventory carrying cost analyzer 205 computes the inventory carrying cost for carrying the raw material for each plant 101 carrying such raw material, such as those plants 101 with an excess amount of the raw material in question (e.g., lithium), by including direct costs, such as warehousing leasing, employee wages, insurance, utilities and taxes, along with indirect costs, such as depreciation and shrinkage. In one embodiment, inventory carrying cost analyzer 205 utilizes the following formula to calculate the inventory carrying cost for carrying the raw material for each plant 101 carrying such raw material:

Inventory Carrying Cost=Capital Costs+Services Costs+Risk Costs+Space Costs

Capital costs refer to the cost of the raw material along with any related cost, such as financing and loan maintenance fees (with or without interest). Service costs refer to the necessary costs to hold or store the raw material, such as at a warehouse at plant 101. These include insurance premiums, taxes and hardware investments. Risk costs refer to the chance that the raw material can become unsaleable before they can be sold, such as because of shrinkage (loss due to damage, theft or errors in record keeping) or obsolescence (loss due to product expiration or retirement). Space or storage costs refer to the costs associated in managing a warehouse, such as renting or purchasing warehouse space, climate control and utilities cost, physical security and handling fees.

In one embodiment, inventory carrying cost analyzer 205 computes the inventory cost for carrying the raw material for each plant 101 carrying such raw material in the manner discussed above using various software tools including, but not limited to, Flowtrac, Infoplus®, Zenventory®, Zangerine®, Fiddle, etc.

Additionally, raw material distributor system 102 includes transportation cost analyzer 206 configured to calculate the transportation cost for transporting raw material (e.g., lithium), such as from plant 101B to plant 101A, where plant 101B has an excess amount of the raw material and where plant 101A needs an additional amount of the raw material to realize the production rate for the product (e.g., lithium-ion battery packs).

In one embodiment, transportation cost analyzer 206 computes the transportation cost for transporting raw material, such as from one plant 101 to another plant 101, by various factors, such as distance, cost of fuel and the weight and density of the raw material being transported. For example, the transportation cost is directly proportional to the distance between the fulfilment center (original pick-up point) and the final destination (e.g., plant 101A). The longer the distance, the higher the cost.

In another example, fuel affects transportation costs.

In a further example, the bigger the weight and density of the shipment of raw material, the higher the transportation cost. The volume, i.e., how much space the raw material occupies, also affects the transportation cost.

Transportation cost analyzer 206 uses a variety of software tools for computing the transportation cost for transporting raw material, such as from one plant 101 to another plant 101, using such factors as discussed above, including, but not limited to, MercuryGate®, JDA®, SAP®, Cerasis®, MPO TMS, etc.

Raw material distributor system 102 additionally includes a raw material distributor analyzer 207 configured to select an amount of raw material (e.g., lithium) to be provided to a plant 101 (e.g., plant 101A) needing an additional amount of the raw material in order to realize the production rate for the product (e.g., lithium-ion battery packs) from a different plant 101 (e.g., plant 101B). In one embodiment, all or a portion of the raw material needed by plant 101 to realize the production rate for the product may be transported by transportation vehicle 106 from a different plant 101 (e.g., plant 101B) of the organization that contains an excess amount of the raw material that plant 101 needs to realize the production rate for the same or similar product using the same raw material.

In one embodiment, after inventory carrying cost analyzer 205 determines the inventory carrying cost from all the plants 101 with an excess amount of the raw material (e.g., lithium) needed to realize the production rate for the same or similar product using the same raw material, raw material distributor analyzer 207 selects the amount of raw material to be provided from one of these plants 101 (e.g., plant 101B) to the plant 101 (e.g., plant 101A) requiring additional raw material to realize the production rate for the product based on minimizing the inventory carrying cost across the system (“system inventory carrying cost”).

The system inventory carrying cost may be minimized based on solving a linear programming program involving the parameters of the inventory carrying cost for each plant 101 as well as the amount of raw material (e.g., lithium) that remains at the plant 101, if any, for carrying over. In one embodiment, various software tools are utilized by raw material distributor analyzer 207 for selecting the amount of raw material (e.g., lithium) to be provided to a plant 101 (e.g., plant 101A) needing an additional amount of the raw material in order to realize the production rate for the product (e.g., lithium-ion battery packs) from a different plant 101 (e.g., plant 101B) of the organization that contains an excess amount of that raw material, including, but not limited to, Fishbowl®, NetSuite®, Striven®, Katana Manufacturing ERP, QT9® ERP, etc.

Raw material distributor system 102 additionally includes a route simulator 208 for simulating the various routes of transporting an amount of raw material (e.g., lithium) to plant 101 (e.g., plant 101A) needing an additional amount of the raw material in order to realize the production rate for the product (e.g., lithium-ion battery packs), such as from a plant 101 (e.g., plant 101B) of the organization that contains an excess amount of the raw material that plant 101 (e.g., plant 101A) needs to realize the production rate for the same or similar product using the same raw material. As discussed above, raw material distributor analyzer 207 may select such an amount of raw material from a selected plant 101 (e.g., plant 101B) to be provided to a different plant 101 (e.g., plant 101A). The various routes between such plants (e.g., plants 101B and 101A) may be simulated by route simulator 208 using various software tools including, but not limited to, FarEye, project44®, FourKites®, SAP®, Tookan®, etc.

In one embodiment, raw material distributor analyzer 207 is configured to select one of the routes simulated by route simulator 208 by selecting the route with the minimum transportation cost. As discussed above, transportation cost analyzer 206 computes the transportation cost for transporting raw material, such as from one plant 101 to another plant 101, by various factors, such as distance, cost of fuel and the weight and density of the raw material being transported. Based on the different routes provided by route simulator 208, transportation cost analyzer 206 computes the transportation cost for transporting raw material using each of these routes. Raw material distributor analyzer 207 then selects the route with the minimum transportation cost.

Furthermore, raw material distributor system 101 includes a feedback engine 209 configured to constantly receive feedback from IoT sensor 105 regarding the current weather conditions, road conditions, vehicle conditions and route details. As previously discussed, in one embodiment, IoT sensors 105 may provide information regarding the current weather conditions, road conditions, vehicle conditions and route details.

Such information may be utilized by raw material distributor analyzer 207 to determine if the route needs to be updated or to alter the amount of the raw material (e.g., lithium) to be provided by the particular transportation vehicle 106. In one embodiment, the analysis discussed above regarding minimizing the system inventory carrying cost and minimizing the system transportation cost is performed with such updated information. For example, the transportation cost may have increased due to poor road or weather conditions or due to a failure in the operability of transportation vehicle 106. As a result, a new analysis will need to be performed by raw material distributor system 106 to determine the amount of raw material to be provided by the various plant(s) 101 with an excess amount of the raw material needed by plant 101 in question to realize its production rate for the product. Additionally, a new analysis will need to be performed by transportation cost analyzer 206 to determine the transportation cost for transporting the selected amount of raw material to be transported from one of the plants 101 (e.g., plant 101B) to the plant 101 (e.g., plant 101A) needing additional raw material to realize its production rate for the product. Furthermore, a new analysis will need to be performed by route simulator 208 to simulate the various routes from various transportation vehicles 106 transporting a selected amount of raw material from the various plants 101 that need to supply the needed raw material to the plant 101 (e.g., plant 101A) needing additional raw material to realize its production rate for the product. Based on such analysis as discussed above, raw material distributor analyzer 207 determines if the route needs to be updated or to alter the amount of the raw material (e.g., lithium) to be provided by the particular transportation vehicle 106. If the route needs to be updated or the amount of the raw material to be provided by the particular transportation vehicle 106 needs to be altered, raw material distributor analyzer 207 proceeds with updating the route or altering the amount of the raw material to be provided by the particular transportation vehicle 106.

Furthermore, in one embodiment, feedback engine 209 receives feedback from production rate engine 202 when there is a change in the predicted production rate, such as a result to changes in the workflow. For example, a new workflow may be generated by workflow generator 201 based on receiving new information from IoT sensors 105, which results in altering the workflow previously generated by workflow generator 201. Based on the changes to the workflow, production rate engine 202 may generate a new predicted production rate. Based on the new predicted production rate, a new analysis will be performed by raw material estimator engine 203, inventory carrying cost analyzer 205, transportation cost analyzer 206 and route simulator 208 so that raw material distributor analyzer 207 can determine if the route needs to be updated or to alter the amount of the raw material (e.g., lithium) to be provided by the particular transportation vehicle 106 as previously discussed.

A further description of these and other features is provided below in connection with the discussion of the method for ensuring that the plant has the required raw material to realize the production rate for a product (e.g., food additive) while minimizing system inventory carrying cost and minimizing system transportation cost.

Prior to the discussion of the method for ensuring that the plant has the required raw material to realize the production rate for a product (e.g., food additive) while minimizing system inventory carrying cost and minimizing system transportation cost, a description of the hardware configuration of raw material distributor system 102 (FIG. 1) is provided below in connection with FIG. 3.

Referring now to FIG. 3, in conjunction with FIG. 1, FIG. 3 illustrates an embodiment of the present disclosure of the hardware configuration of raw material distributor system 102 which is representative of a hardware environment for practicing the present disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 300 contains an example of an environment for the execution of at least some of the computer code 301 involved in performing the inventive methods, such as ensuring that the plant, such as plant 101, has the required raw material to realize the production rate for a product (e.g., food additive) while minimizing system inventory carrying cost and minimizing system transportation cost. In addition to block 301, computing environment 300 includes, for example, raw material distributor system 102, network 103, such as a wide area network (WAN), end user device (EUD) 302, remote server 303, public cloud 304, and private cloud 305. In this embodiment, raw material distributor system 102 includes processor set 306 (including processing circuitry 307 and cache 308), communication fabric 309, volatile memory 310, persistent storage 311 (including operating system 312 and block 301, as identified above), peripheral device set 313 (including user interface (UI) device set 314, storage 315, and Internet of Things (IoT) sensor set 316), and network module 317. Remote server 303 includes remote database 318. Public cloud 304 includes gateway 319, cloud orchestration module 320, host physical machine set 321, virtual machine set 322, and container set 323.

Raw material distributor system 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 318. As is well understood in the art of computer technology, and depending upon the technology, performance of a computer-implemented method may be distributed among multiple computers and/or between multiple locations. On the other hand, in this presentation of computing environment 300, detailed discussion is focused on a single computer, specifically raw material distributor system 102, to keep the presentation as simple as possible. Raw material distributor system 102 may be located in a cloud, even though it is not shown in a cloud in FIG. 3. On the other hand, raw material distributor system 102 is not required to be in a cloud except to any extent as may be affirmatively indicated.

Processor set 306 includes one, or more, computer processors of any type now known or to be developed in the future. Processing circuitry 307 may be distributed over multiple packages, for example, multiple, coordinated integrated circuit chips. Processing circuitry 307 may implement multiple processor threads and/or multiple processor cores. Cache 308 is memory that is located in the processor chip package(s) and is typically used for data or code that should be available for rapid access by the threads or cores running on processor set 306. Cache memories are typically organized into multiple levels depending upon relative proximity to the processing circuitry. Alternatively, some, or all, of the cache for the processor set may be located “off chip.” In some computing environments, processor set 306 may be designed for working with qubits and performing quantum computing.

Computer readable program instructions are typically loaded onto raw material distributor system 102 to cause a series of operational steps to be performed by processor set 306 of raw material distributor system 102 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 308 and the other storage media discussed below. The program instructions, and associated data, are accessed by processor set 306 to control and direct performance of the inventive methods. In computing environment 300, at least some of the instructions for performing the inventive methods may be stored in block 301 in persistent storage 311.

Communication fabric 309 is the signal conduction paths that allow the various components of raw material distributor system 102 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 310 is any type of volatile memory now known or to be developed in the future. Examples include dynamic type random access memory (RAM) or static type RAM. Typically, the volatile memory is characterized by random access, but this is not required unless affirmatively indicated. In raw material distributor system 102, the volatile memory 310 is located in a single package and is internal to raw material distributor system 102, but, alternatively or additionally, the volatile memory may be distributed over multiple packages and/or located externally with respect to raw material distributor system 102.

Persistent Storage 311 is any form of non-volatile storage for computers that is now known or to be developed in the future. The non-volatility of this storage means that the stored data is maintained regardless of whether power is being supplied to raw material distributor system 102 and/or directly to persistent storage 311. Persistent storage 311 may be a read only memory (ROM), but typically at least a portion of the persistent storage allows writing of data, deletion of data and re-writing of data. Some familiar forms of persistent storage include magnetic disks and solid state storage devices. Operating system 312 may take several forms, such as various known proprietary operating systems or open source Portable Operating System Interface type operating systems that employ a kernel. The code included in block 301 typically includes at least some of the computer code involved in performing the inventive methods.

Peripheral device set 313 includes the set of peripheral devices of raw material distributor system 102. Data communication connections between the peripheral devices and the other components of raw material distributor system 102 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 314 may include components such as a display screen, speaker, microphone, wearable devices (such as goggles and smart watches), keyboard, mouse, printer, touchpad, game controllers, and haptic devices. Storage 315 is external storage, such as an external hard drive, or insertable storage, such as an SD card. Storage 315 may be persistent and/or volatile. In some embodiments, storage 315 may take the form of a quantum computing storage device for storing data in the form of qubits. In embodiments where raw material distributor system 102 is required to have a large amount of storage (for example, where raw material distributor system 102 locally stores and manages a large database) then this storage may be provided by peripheral storage devices designed for storing very large amounts of data, such as a storage area network (SAN) that is shared by multiple, geographically distributed computers. IoT sensor set 316 is made up of sensors that can be used in Internet of Things applications. For example, one sensor may be a thermometer and another sensor may be a motion detector.

Network module 317 is the collection of computer software, hardware, and firmware that allows raw material distributor system 102 to communicate with other computers through WAN 103. Network module 317 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 317 are performed on the same physical hardware device. In other embodiments (for example, embodiments that utilize software-defined networking (SDN)), the control functions and the forwarding functions of network module 317 are performed on physically separate devices, such that the control functions manage several different network hardware devices. Computer readable program instructions for performing the inventive methods can typically be downloaded to raw material distributor system 102 from an external computer or external storage device through a network adapter card or network interface included in network module 317.

WAN 103 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 302 is any computer system that is used and controlled by an end user (for example, a customer of an enterprise that operates raw material distributor system 102), and may take any of the forms discussed above in connection with raw material distributor system 102. EUD 302 typically receives helpful and useful data from the operations of raw material distributor system 102. For example, in a hypothetical case where raw material distributor system 102 is designed to provide a recommendation to an end user, this recommendation would typically be communicated from network module 317 of raw material distributor system 102 through WAN 103 to EUD 302. In this way, EUD 302 can display, or otherwise present, the recommendation to an end user. In some embodiments, EUD 302 may be a client device, such as thin client, heavy client, mainframe computer, desktop computer and so on.

Remote server 303 is any computer system that serves at least some data and/or functionality to raw material distributor system 102. Remote server 303 may be controlled and used by the same entity that operates raw material distributor system 102. Remote server 303 represents the machine(s) that collect and store helpful and useful data for use by other computers, such as raw material distributor system 102. For example, in a hypothetical case where raw material distributor system 102 is designed and programmed to provide a recommendation based on historical data, then this historical data may be provided to raw material distributor system 102 from remote database 318 of remote server 303.

Public cloud 304 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 304 is performed by the computer hardware and/or software of cloud orchestration module 320. The computing resources provided by public cloud 304 are typically implemented by virtual computing environments that run on various computers making up the computers of host physical machine set 321, which is the universe of physical computers in and/or available to public cloud 304. The virtual computing environments (VCEs) typically take the form of virtual machines from virtual machine set 322 and/or containers from container set 323. It is understood that these VCEs may be stored as images and may be transferred among and between the various physical machine hosts, either as images or after instantiation of the VCE. Cloud orchestration module 320 manages the transfer and storage of images, deploys new instantiations of VCEs and manages active instantiations of VCE deployments. Gateway 319 is the collection of computer software, hardware, and firmware that allows public cloud 304 to communicate through WAN 103.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 305 is similar to public cloud 304, except that the computing resources are only available for use by a single enterprise. While private cloud 305 is depicted as being in communication with WAN 103 in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 304 and private cloud 305 are both part of a larger hybrid cloud.

Block 301 further includes the software components discussed above in connection with FIG. 2 to ensure that plant 101 has the required raw material to realize the production rate for a product (e.g., food additive) while minimizing system inventory carrying cost and minimizing system transportation cost. In one embodiment, such components may be implemented in hardware. The functions discussed above performed by such components are not generic computer functions. As a result, raw material distributor system 102 is a particular machine that is the result of implementing specific, non-generic computer functions.

In one embodiment, the functionality of such software components of raw material distributor system 102, including the functionality for ensuring that plant 101 has the required raw material to realize the production rate for a product (e.g., food additive) while minimizing system inventory carrying cost and minimizing system transportation cost may be embodied in an application specific integrated circuit.

As stated above, capacity planning software is a programmable solution that helps manufacturing organizations understand the actual production capacity needed to address fluctuating demands for its products and services. Furthermore, capacity planning software helps companies compare production loads with available capacity within a specific time frame. The process of planning for capacity helps avoid bottlenecks in production which can impact the entire supply chain. Organizations may utilize multiple manufacturing plants to manufacture a product. A manufacturing plant (also referred to as a “production plant” or simply a “plant”) is an industrial facility, often a complex consisting of several buildings filled with machinery, whose workers manufacture items or operate machines which process each item into another. Such plants, at times, may have excess or a shortage amount of raw materials that are required in the production process. A raw material, also known as a feedstock, unprocessed material, or primary commodity, is a basic material that is used to produce goods, finished goods, energy, or intermediate materials that are feedstock for future finished products. A raw material is a material in an unprocessed or minimally processed state, such as raw latex, crude oil, cotton, coal, raw biomass, iron ore, air, logs, water or any product of agriculture, forestry, fishing or mineral in its natural form or which has undergone the transformation required to prepare it for marketing in substantial volumes. When plants have an excess or a shortage amount of raw materials, capacity planning software may utilize such information in an attempt to ensure that each plant in the organization has an adequate amount of raw materials to produce the required amount of products. Unfortunately, such capacity planning software tools fail to ensure that each plant in the organization has the required minimum amount of raw materials needed to produce the required amount of products while minimizing the organization's inventory carrying cost. “Inventory carrying cost,” as used herein, refers to the expenses that arise from keeping raw materials at the plant, such as being shelved at the plant. Neither do such software tools consider transportation cost, such as the cost for distributing the raw materials to the various plants, including from one plant to another plant. As a result, such capacity planning tools are deficient in meeting the organization's plant capacity needs while minimizing cost, such as the organization's inventory carrying cost and the organization's transportation cost.

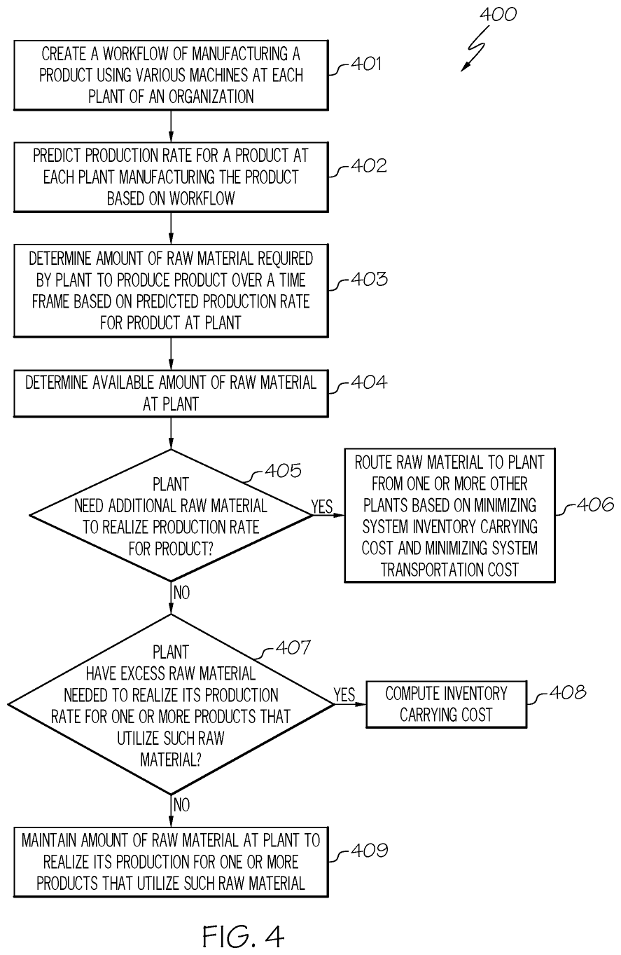

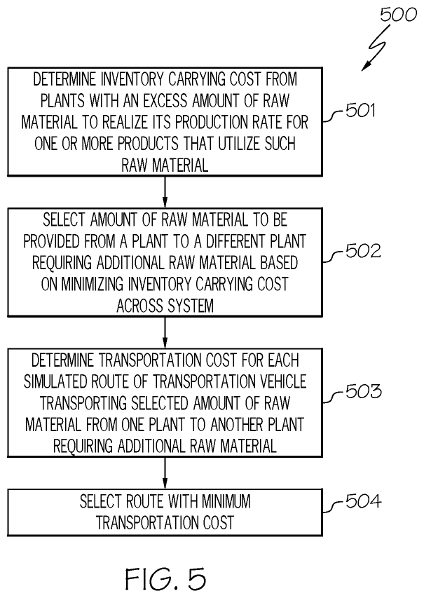

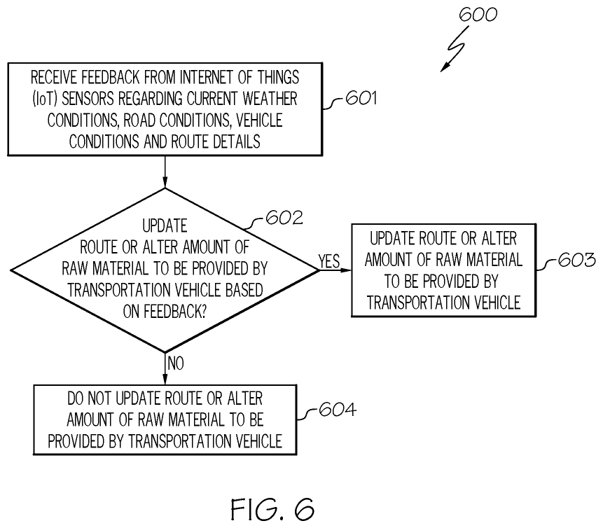

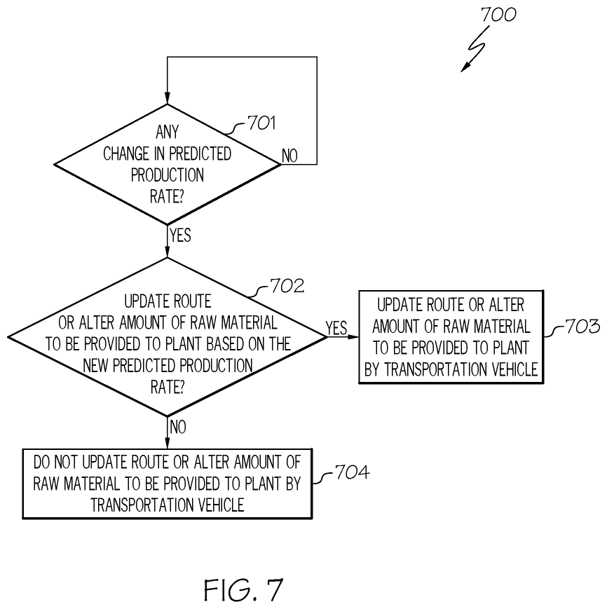

The embodiments of the present disclosure provide a means for meeting the organization's plant capacity needs by ensuring that a plant has the required amount of raw material to realize the production rate for a product (e.g., food additive) while minimizing system inventory carrying cost and minimizing system transportation cost as discussed below in connection with FIGS. 4-7. FIG. 4 is a flowchart of a method for ensuring that a plant (e.g., plant 101) has the required amount of raw material to realize the production rate for a product while minimizing system inventory carrying cost and minimizing system transportation cost. FIG. 5 is a flowchart of a method for selecting the amount of raw material to be transported to the plant in need of additional raw material and the route for such transportation. FIG. 6 is a flowchart of a method for updating the route or altering the amount of raw material to be transported in response to feedback provided by Internet of Things (IoT) sensors. FIG. 7 is a flowchart of a method for updating the route or altering the amount of raw material to be transported in response to changes in the predicted production rate.

As stated above, FIG. 4 is a flowchart of a method 400 for ensuring that a plant (e.g., plant 101) has the required amount of raw material to realize the production rate for a product while minimizing system inventory carrying cost and minimizing system transportation cost in accordance with an embodiment of the present disclosure.

Referring to FIG. 4, in conjunction with FIGS. 1-3, in operation 401, workflow generator 201 of raw material distributor system 102 creates a workflow of manufacturing a product using various machines at each plant 101 of an organization, where the workflow illustrates which machines are being utilized to produce a product (e.g., food additive) using one or more raw materials (e.g., biomass).

As discussed above, a “workflow,” as used herein, refers to a sequence of machines being utilized to manufacture a product from initiation to completion using one or more raw materials. In one embodiment, workflow generator 201 generates such a workflow based on feedback received from IoT sensors 105 monitoring the raw material (e.g., lumber) that is used to manufacture a product (e.g., table) using a series of machines (e.g., single multi-purpose machine that is able to joint, plane and edge in a single pass, table saw, computer numerical control (CNC) router, sander and finishing booth). For example, IoT sensors 105 may monitor the raw material (e.g., lumber) that is first passed to a single multi-purpose machine that is able to joint, plane and edge in a single pass. Jointers take the warp and bend out of the bottom of the board so that it will lie flat when it goes through the planer. Planers flatten the top of the board and cut it down to the desired thickness. Edgers take the rough wood and any warp or bend off the sides of the board. The next step is to cut across the board using a table saw according to a user-designated specification followed by utilizing the computer numerical control (CNC) router to cut coves, mortises and slots as well as various shaping tasks. In one embodiment, the desired shape is entered into a computer and the CNC router is then robotically manipulated by the machine. Afterwards, the wooden panel is fed through stationary sanders made of rotating belt(s) with a feed table beneath them. Such a sander is used to sand the surfaces of the wood and to smooth out glue joints. Lastly, protective finishes, such as polyurethane, are sprayed onto the furniture as a final step in its manufacture at a finishing booth.

In one embodiment, IoT sensors 105 monitor the sequence of machines (e.g., single multi-purpose machine that is able to joint, plane and edge in a single pass, table saw, computer numerical control (CNC) router, sander and finishing booth) being utilized to manufacture a product (e.g., table) from initiation to completion using raw material (e.g., lumber) by placing such IoT sensors 105 on or near the raw material and machines.

In one embodiment, such workflows include metadata, which includes timing information, such as the duration of time to complete each task in the manufacturing process. For example, during the manufacturing of a table, the workflow may include metadata, which includes the timing information for completing each step performed by the machines of a single multi-purpose machine that is able to joint, plane and edge in a single pass, a table saw, a computer numerical control (CNC) router, a sander and a finishing booth. In one embodiment, such timing information may be obtained from IoT sensors 105 monitoring such machines which may time the task performed by such machines from initiation to completion.

In one embodiment, such metadata further includes the amount of raw material that was used to produce the product in the manufacturing process. For example, such metadata may include the amount of 8 kilograms of lithium that is needed to make a single lithium-ion battery pack for a single electric car. In one embodiment, such information may be obtained from IoT sensors 105 monitoring the amount of raw material being used to manufacture a product (e.g., lithium-ion battery pack). In one embodiment, such metadata is provided by an expert, who inputs such information in raw material distributor system 102.

In one embodiment, such workflows, including the associated metadata, are stored in a storage device (e.g., storage device 311, 315) of raw material distributor system 102.

In one embodiment, workflow generator 201 creates such a workflow based on feedback provided by IoT sensors 105 discussed above using various software tools, including, but not limited to, nTask®, Automate.io, ClickUp®, KissFlow®, Hive®, etc.

In operation 402, production rate engine 202 of raw material distributor system 102 predicts a production rate for a product (e.g., table) at each plant 101 (e.g., plant 101A, 101B, 101C) manufacturing the product based on the workflow (workflow for manufacturing the product using machines at the plant) that was created by workflow generator 201.

As discussed above, the “production rate,” as used herein, refers to the volume or number of units of a product (e.g., table, food additive) that can be produced during a given period of time (e.g., ten hours).

In one embodiment, the current production rate is determined by production rate engine 202 utilizing the metadata associated with the workflow. For example, it may take a total of 3 hours to manufacture a table using the machines discussed above from initiation until completion. As a result, the production rate is 3 tables over a 9 hour period of time. In one embodiment, the period of time upon which the production rate is based is user-designated.

In one embodiment, production rate engine 202 is configured to predict a future production rate using past production rates. For example, the past production rates for a product at plant 101 over a one month period of time may be utilized for predicting the production rate of the product over the next two days. Such a prediction may be performed by production rate engine 202 using time series analysis or causal modeling. In one embodiment, such a prediction is performed by production rate engine 202 using the moving average method in which a range of data points is created based on a series of averages from the full data set (e.g., past production rates for a product over the past month). In one embodiment, such a prediction is performed by production rate engine 202 using the trend projection method in which the past trends are assumed to continue in the future at roughly the same rate.

In one embodiment, production rate engine 202 predicts the future production rate using a machine learning model configured to predict the future production rate of a product by plant 101.

In one embodiment, production rate engine 202 trains a model to predict the future production rate of a product by plant 101 based on the past production rate of manufacturing the product by a particular plant 101.

In one embodiment, production rate engine 202 uses a machine learning algorithm (e.g., supervised learning) to build the model to predict the future production rate of a product by plant 101 using a sample data set containing past production rates for the product by the plant in question.

Such a sample data set is referred to herein as the “training data,” which is used by the machine learning algorithm to make predictions or decisions as to the future production rate of the product by plant 101. The algorithm iteratively makes predictions on the training data as to the future production rate of the product by plant 101 until the predictions achieve the desired accuracy as determined by an expert. Examples of such learning algorithms include nearest neighbor, Naïve Bayes, decision trees, linear regression, support vector machines and neural networks.

In operation 403, raw material estimator engine 203 of raw material distributor system 102 determines an amount of raw material (e.g., biomass) required by plant 101 (e.g., plant 101A) to produce the product (e.g., food additive) over a time frame, which may be user-designated, based on the predicted production rate for the product at plant 101 (e.g., plant 101A).

As stated above, in one embodiment, raw material estimator engine 203 determines such an amount based on metadata associated with the workflow generated by workflow generator 201. As also stated above, the metadata associated with the workflow created by workflow generator 201 may include the amount of raw material that was used to produce the product in the manufacturing process. For example, such metadata may include the amount of 8 kilograms of lithium that is needed to make a single lithium-ion battery pack.

After obtaining such information, raw material estimator engine 203 estimates the total amount of raw material needed to realize the production rate of the product at plant 101 (e.g., plant 101A). For example, if plant 101 is predicted to have a production rate of 1,000 lithium-ion battery packs over the next 9 hours, and the metadata indicates that 8 kilograms of lithium is needed to make a single lithium-ion battery pack, then raw material estimator engine 203 may determine, based on such information, that an amount of 8,000 kilograms of lithium is needed to realize the production rate of 1,000 lithium-ion battery packs over the next 9 hours.

In one embodiment, raw material estimator engine 203 uses various software tools for determining the amount of raw material (e.g., biomass) required by plant 101 (e.g., plant 101A) to produce the product (e.g., food additive) over a time frame, including, but not limited to, Fishbowl®, NetSuite®, Striven®, Katana Manufacturing ERP, QT9® ERP, etc.

In operation 404, inventory engine 204 of raw material distributor system 102 determines the available amount of raw material (e.g., lithium) at plant 101 (e.g., plant 101A).

As discussed above, in one embodiment, inventory engine 204 determines the available amount of raw material based on the information provided by IoT sensors 105 which indicates the amount of raw material that is currently available to be utilized by plant 105. For example, such IoT sensors 105 may be placed at or near the raw material (e.g., lithium) and keep track of the amount of raw material being utilized by the machines in the manufacturing process at plant 101 (e.g., plant 101A).

In one embodiment, inventory engine 204 uses various software tools to determine the current available amount of raw material (e.g., lithium) at plant 101 (e.g., plant 101A) using the information provided by IoT sensors 105 (e.g., amount of raw material being utilized by machines at plant 101), including, but not limited to, Fishbowl®, NetSuite®, Striven®, Katana Manufacturing ERP, QT9® ERP, etc.

In operation 405, raw material distributor analyzer 207 of raw material distributor system 102 determines whether plant 101 needs additional raw material (e.g., biomass) to realize the production rate for the product (e.g., food additive).

If plant 101 needs additional raw material (e.g., biomass) to realize the production rate for the product (e.g., food additive), then, in operation 406, raw material distributor analyzer 207 of raw material distributor system 102 routes an amount of the raw material (e.g., biomass) to plant 101 (e.g., plant 101A) from one or more other plants based on minimizing the system inventory carrying cost and minimizing the system transportation cost.

As discussed above, raw material distributor analyzer 207 selects an mount of raw material (e.g., lithium) to be provided to a plant 101 (e.g., plant 101A) needing an additional amount of the raw material in order to realize the production rate for the product (e.g., lithium-ion battery packs) from a different plant 101 (e.g., plant 101B). In one embodiment, all or a portion of the raw material needed by plant 101 to realize the production rate for the product may be transported by transportation vehicle 106 from a different plant 101 (e.g., plant 101B) of the organization that contains an excess amount of the raw material that plant 101 needs to realize the production rate for the same or similar product using the same raw material.

In one embodiment, after inventory carrying cost analyzer 205 determines the inventory carrying cost from all the plants 101 with an excess amount of the raw material (e.g., lithium) needed to realize the production rate for the same or similar product using the same raw material, raw material distributor analyzer 207 selects the amount of raw material to be provided from one of these plants 101 (e.g., plant 101B) to the plant 101 (e.g., plant 101A) requiring additional raw material to realize the production rate for the product based on minimizing the inventory carrying cost across the system (“system inventory carrying cost”).

The system inventory carrying cost may be minimized based on solving a linear programming program involving the parameters of the inventory carrying cost for each plant 101 as well as the amount of raw material (e.g., lithium) that remains at the plant 101, if any, for carrying over. In one embodiment, various software tools are utilized by raw material distributor analyzer 207 for selecting the amount of raw material (e.g., lithium) to be provided to a plant 101 (e.g., plant 101A) needing an additional amount of the raw material in order to realize the production rate for the product (e.g., lithium-ion battery packs) from a different plant 101 (e.g., plant 101B) of the organization that contains an excess amount of that raw material, including, but not limited to, Fishbowl®, NetSuite®, Striven®, Katana Manufacturing ERP, QT9® ERP, etc.

Furthermore, as previously discussed, route simulator 208 is configured to simulate the various routes of transporting an amount of raw material (e.g., lithium) to a plant 101 (e.g., plant 101A) needing an additional amount of the raw material in order to realize the production rate for the product (e.g., lithium-ion battery packs), such as from a plant 101 (e.g., pant 101B) of the organization that contains an excess amount of the raw material that plant 101 (e.g., plant 101A) needs to realize the production rate for the same or similar product using the same raw material. As discussed above, raw material distributor analyzer 207 may select such an amount of raw material from a selected plant 101 (e.g., plant 101B) to be provided to a different plant 101 (e.g., plant 101A). The various routes between such plants (e.g., plants 101B and 101A) may be simulated by route simulator 208 using various software tools including, but not limited to, FarEye, project44®, FourKites®, SAP®, Tookan®, etc.

In one embodiment, raw material distributor analyzer 207 is configured to select one of the routes simulated by route simulator 208 by selecting the route with the minimum transportation cost. As discussed above, transportation cost analyzer 206 computes the transportation cost for transporting raw material, such as from one plant 101 to another plant 101, by various factors, such as distance, cost of fuel and the weight and density of the raw material being transported. Based on the different routes provided by route simulator 208, transportation cost analyzer 206 computes the transportation cost for transporting raw material using each of these routes. Raw material distributor analyzer 207 then selects the route with the minimum transportation cost.

A further discussion regarding routing an amount of the raw material (e.g., biomass) to plant 101 (e.g., plant 101A) from one or more other plants based on minimizing the system inventory carrying cost and minimizing the system transportation cost is provided below in connection with FIG. 5.

Referring to operation 405, if, however, plant 101 does not need additional raw material (e.g., biomass) to realize the production rate for the product (e.g., food additive), then, in operation 407, inventory carrying cost analyzer 205 of raw material distributor system 102 determines whether plant 101 has an excess amount of raw material (e.g., biomass) needed to realize its production rate for one or more products that utilize such raw material.

If plant 101 has an excess amount of raw material (e.g., biomass) needed to realize its production rate for one or more products that utilize such raw material, then, in operation 408, inventory carrying cost analyzer 205 of raw material distributor system 102 computes the inventory carry cost for such a plant 101.

As stated above, in such cases, inventory carrying cost analyzer 205 determines the inventory carrying cost for carrying the raw material (e.g., lithium) for each plant 101 carrying such raw material, such as those plants 101 with an excess amount of the raw material in question (e.g., lithium). “Inventory carrying cost,” as used herein, refers to the expenses that arise from keeping raw materials at the plant, such as being shelved at the plant. “System inventory carrying cost,” as used herein, refers to the inventory carrying cost of system 100 across all plants 101.

In one embodiment, inventory carrying cost analyzer 205 computes the inventory carrying cost for carrying the raw material for each plant 101 carrying such raw material, such as those plants 101 with an excess amount of the raw material in question (e.g., lithium), by including direct costs, such as warehousing leasing, employee wages, insurance, utilities and taxes, along with indirect costs, such as depreciation and shrinkage. In one embodiment, inventory carrying cost analyzer 205 utilizes the following formula to calculate the inventory carrying cost for carrying the raw material for each plant 101 carrying such raw material:

Inventory Carrying Cost=Capital Costs+Services Costs+Risk Costs+Space Costs

Capital costs refer to the cost of the raw material along with any related cost, such as financing and loan maintenance fees (with or without interest). Service costs refer to the necessary costs to hold or store the raw material, such as at a warehouse at plant 101. These include insurance premiums, taxes and hardware investments. Risk costs refer to the chance that the raw material can become unsaleable before they can be sold, such as because of shrinkage (loss due to damage, theft or errors in record keeping) or obsolescence (loss due to product expiration or retirement). Space or storage costs refer to the costs associated in managing a warehouse, such as renting or purchasing warehouse space, climate control and utilities cost, physical security and handling fees.

In one embodiment, inventory carrying cost analyzer 205 computes the inventory cost for carrying the raw material for each plant 101 carrying such raw material in the manner discussed above using various software tools including, but not limited to, Flowtrac, Infoplus®, Zenventory®, Zangerine®, Fiddle, etc.

Referring to operation 407, if, however, plant 101 does not have an excess amount of raw material (e.g., biomass) needed to realize its production rate for one or more products that utilize such raw material, then, in operation 409, raw material distributor analyzer 207 of raw material distributor system 102 maintains the amount of raw material at plant 101 (e.g., plant 101A) to realize its production for one or more products that utilize such raw material.

A further discussion regarding selecting the amount of raw material to be transported to plant 101 in need of additional raw material and the route for such transportation, including routing an amount of the raw material (e.g., biomass) to plant 101 (e.g., plant 101A) from one or more other plants, based on minimizing the system inventory carrying cost and minimizing the system transportation cost, is provided below in connection with FIG. 5.

FIG. 5 is a flowchart of a method 500 for selecting the amount of raw material to be transported to the plant in need of additional raw material and the route for such transportation in accordance with an embodiment of the present disclosure.

Referring to FIG. 5, in conjunction with FIGS. 1-4, in operation 501, inventory carrying cost analyzer 205 of raw material distributor system 102 determines an inventory carrying cost from plants 101 with an excess amount of raw material to realize its production rate for one or more products that utilize such raw material.

As discussed above, inventory carrying cost analyzer 205 is configured to determine the inventory carrying cost for carrying the raw material (e.g., lithium) for each plant 101 carrying such raw material, such as those plants 101 with an excess amount of the raw material in question (e.g., lithium). “Inventory carrying cost,” as used herein, refers to the expenses that arise from keeping raw materials at the plant, such as being shelved at the plant. “System inventory carrying cost,” as used herein, refers to the inventory carrying cost of system 100 across all plants 101.

In one embodiment, inventory carrying cost analyzer 205 computes the inventory carrying cost for carrying the raw material for each plant 101 carrying such raw material, such as those plants 101 with an excess amount of the raw material in question (e.g., lithium), by including direct costs, such as warehousing leasing, employee wages, insurance, utilities and taxes, along with indirect costs, such as depreciation and shrinkage. In one embodiment, inventory carrying cost analyzer 205 utilizes the following formula to calculate the inventory carrying cost for carrying the raw material for each plant 101 carrying such raw material:

Inventory Carrying Cost=Capital Costs+Services Costs+Risk Costs+Space Costs

Capital costs refer to the cost of the raw material along with any related cost, such as financing and loan maintenance fees (with or without interest). Service costs refer to the necessary costs to hold or store the raw material, such as at a warehouse at plant 101. These include insurance premiums, taxes and hardware investments. Risk costs refer to the chance that the raw material can become unsaleable before they can be sold, such as because of shrinkage (loss due to damage, theft or errors in record keeping) or obsolescence (loss due to product expiration or retirement). Space or storage costs refer to the costs associated in managing a warehouse, such as renting or purchasing warehouse space, climate control and utilities cost, physical security and handling fees.

In one embodiment, inventory carrying cost analyzer 205 computes the inventory cost for carrying the raw material for each plant 101 carrying such raw material in the manner discussed above using various software tools including, but not limited to, Flowtrac, Infoplus®, Zenventory®, Zangerine®, Fiddle, etc.

In operation 502, raw material distributor analyzer 207 of raw material distributor system 102 selects an amount of raw material (e.g., biomass) to be provided from a plant 101 (e.g., plant 101B) to plant 101 (e.g., plant 101A) requiring additional raw material to realize the production rate for the product based on minimizing the inventory carrying cost across the system (“system inventory carrying cost”).

As discussed above, in one embodiment, after inventory carrying cost analyzer 205 determines the inventory carrying cost from all the plants 101 with an excess amount of the raw material (e.g., lithium) needed to realize the production rate for the same or similar product using the same raw material, raw material distributor analyzer 207 selects the amount of raw material to be provided from one of these plants 101 (e.g., plant 101B) to the plant 101 (e.g., plant 101A) requiring additional raw material to realize the production rate for the product based on minimizing the inventory carrying cost across the system (“system inventory carrying cost”).

The system inventory carrying cost may be minimized based on solving a linear programming program involving the parameters of the inventory carrying cost for each plant 101 as well as the amount of raw material (e.g., lithium) that remains at the plant 101, if any, for carrying over. In one embodiment, various software tools are utilized by raw material distributor analyzer 207 for selecting the amount of raw material (e.g., lithium) to be provided to a plant 101 (e.g., plant 101A) needing an additional amount of the raw material in order to realize the production rate for the product (e.g., lithium-ion battery packs) from a different plant 101 (e.g., plant 101B) of the organization that contains an excess amount of that raw material, including, but not limited to, Fishbowl®, NetSuite®, Striven®, Katana Manufacturing ERP, QT9® ERP, etc.

In operation 503, transportation cost analyzer 206 of raw material distributor system 102 determines the transportation cost for each simulated route of transportation vehicle 106 transporting the selected amount of raw material from a plant 101 (e.g., plant 101B) to plant 101 (e.g., plant 101A) needing an additional amount of the raw material in order to realize the production rate for the product (e.g., lithium-ion battery packs).

As discussed above, route simulator 208 of raw material distributor system 102 simulates the various routes of transporting the selected amount of raw material (e.g., lithium) to a plant 101 (e.g., plant 101A) needing an additional amount of the raw material in order to realize the production rate for the product (e.g., lithium-ion battery packs), such as from a plant 101 (e.g., plant 101B) of the organization that contains an excess amount of the raw material that plant 101 needs to realize the production rate for the same or similar product using the same raw material. The various routes between such plants (e.g., plants 101B and 101A) may be simulated by route simulator 208 using various software tools including, but not limited to, FarEye, project44®, FourKites®, SAP®, Tookan®, etc.

Additionally, as discussed above, transportation cost analyzer 206 calculates the transportation cost for transporting raw material (e.g., lithium), such as from plant 101B to plant 101A, where plant 101B has an excess amount of the raw material and where plant 101A needs an additional amount of the raw material to realize the production rate for the product (e.g., lithium-ion battery packs).

In one embodiment, transportation cost analyzer 206 computes the transportation cost for transporting raw material, such as from one plant 101 to another plant 101, by various factors, such as distance, cost of fuel and the weight and density of the raw material being transported. For example, the transportation cost is directly proportional to the distance between the fulfilment center (original pick-up point) and the final destination (e.g., plant 101A). The longer the distance, the higher the cost.

In another example, fuel affects transportation costs.

In a further example, the bigger the weight and density of the shipment of raw material, the higher the transportation cost. The volume, i.e., how much space the raw material occupies, also affects the transportation cost.

Transportation cost analyzer 206 uses a variety of software tools for computing the transportation cost for transporting raw material, such as from one plant 101 to another plant 101, using such factors as discussed above, including, but not limited to, MercuryGate®, JDA®, SAP®, Cerasis®, MPO TMS, etc.

In operation 504, raw material distributor analyzer 207 of raw material distributor system 102 selects the route with the minimum transportation cost.

As stated above, in one embodiment, raw material distributor analyzer 207 is configured to select one of the routes simulated by route simulator 208 by selecting the route with the minimum transportation cost. As discussed above, transportation cost analyzer 206 computes the transportation cost for transporting raw material, such as from one plant 101 to another plant 101, by various factors, such as distance, cost of fuel and the weight and density of the raw material being transported. Based on the different routes provided by route simulator 208, transportation cost analyzer 206 computes the transportation cost for transporting raw material using each of these routes. Raw material distributor analyzer 207 then selects the route with the minimum transportation cost.

Such a route may be updated or the amount of raw material to be transported may be altered in response to feedback provided by IoT sensors 105 as discussed below in connection with FIG. 6.

FIG. 6 is a flowchart of a method 600 for updating the route or altering the amount of raw material to be transported in response to feedback provided by Internet of Things (IoT) sensors 105 in accordance with an embodiment of the present disclosure.

Referring to FIG. 6, in conjunction with FIGS. 1-5, in operation 601, raw material distributor analyzer 207 of raw material distributor system 102 receives feedback from Internet of Things (IoT) sensors 105 regarding current weather conditions, road conditions, vehicle conditions and route details.

As discussed above, in one embodiment, IoT sensors 105 may provide information regarding the current weather conditions, road conditions, vehicle conditions and route details. For example, IoT sensors 105 may be implemented in a weather monitoring system in which IoT sensors 105 measure the physical parameters of a certain location (e.g., light, temperature, wind, moisture, pressure, etc.) and provide such details to raw material distributor system 102 via server 104, whether directly or indirectly, such as by uploading them in real-time to cloud storage, where the data can be analyzed immediately, such as by raw material distributor system 102.

In another example, IoT sensors 105 may be utilized in a traffic management system (e.g., IoT sensors 105 are placed on roads, highways, etc.) to monitor, analyze and share traffic data, such as traffic congestion, accidents, etc. Such information may be used to provide information regarding road conditions and route details. For instance, such information may be provided to raw material distributor system 102 via server 104, where raw material distributor system 102 could use such information to determine optimal routes based on accidents, traffic jams, etc. using various software tools, such as Waze, etc.

In another example, IoT sensors 105 may be utilized in vehicles, such as transportation vehicles 106, to constantly monitor vehicle conditions. For example, such IoT sensors 105 may gather real-time data on fuel consumption, engine temperature, fluid levels, etc. Such information may be provided to raw material distributor system 102 via server 104 to detect pre-failure conditions prior to failures thereby avoiding unnecessary expenses. When such issues require maintenance, raw material distributor system 102 may update a route or alter the amount of raw material being transported by transportation vehicle 106.

In one embodiment, such IoT sensors 105 may be used to provide location information of transportation vehicles 106, amount of raw material being transported on transportation vehicle 106, etc.

In operation 602, raw material distributor analyzer 207 of raw material distributor system 102 determines whether the selected route is to be updated or the amount of raw material to be provided by transportation vehicle 106 to plant 101 (e.g., plant 101A) that needs an additional amount of the raw material to realize the production rate for the product (e.g., lithium-ion battery packs) needs to be altered based on the feedback received in operation 601.

If the selected route is to be updated or the amount of raw material to be provided by transportation vehicle 106 to plant 101 (e.g., plant 101A) that needs an additional amount of the raw material to realize the production rate for the product (e.g., lithium-ion battery packs) is to be altered, then, in operation 603, raw material distributor analyzer 207 of raw material distributor system 102 updates the route or alters the amount of raw material (e.g., biomass) to be provided to plant 101 (e.g., plant 101A) by transportation vehicle 106.

As stated above, in one embodiment, the feedback information provided by IoT sensors 105 is utilized by raw material distributor analyzer 207 to determine if the route needs to be updated or to alter the amount of the raw material (e.g., lithium) to be provided by the particular transportation vehicle 106. In one embodiment, the analysis discussed above regarding minimizing the system inventory carrying cost and minimizing the system transportation cost is performed with such updated information (feedback information provided by IoT sensors 105). For example, the transportation cost may have increased due to poor road or weather conditions or due to a failure in the operability of transportation vehicle 106. As a result, a new analysis will need to be performed by raw material distributor system 106 to determine the amount of raw material to be provided by the various plant(s) 101 with an excess amount of the raw material needed by plant 101 in question to realize its production rate for the product. Additionally, a new analysis will need to be performed by transportation cost analyzer 206 to determine the transportation cost for transporting the selected amount of raw material to be transported from one of the plants 101 (e.g., plant 101B) to the plant 101 (e.g., plant 101A) needing additional raw material to realize its production rate for the product. Furthermore, a new analysis will need to be performed by route simulator 208 to simulate the various routes from various transportation vehicles 106 transporting a selected amount of raw material from the various plants 101 that need to supply the needed raw material to the plant 101 (e.g., plant 101A) needing additional raw material to realize its production rate for the product. Based on such analysis as discussed above, raw material distributor analyzer 207 determines if the route needs to be updated or to alter the amount of the raw material (e.g., lithium) to be provided by the particular transportation vehicle 106. If the route needs to be updated or the amount of the raw material to be provided by the particular transportation vehicle 106 needs to be altered, raw material distributor analyzer 207 proceeds with updating the route or altering the amount of the raw material to be provided by the particular transportation vehicle 106.

If, however, the selected route is not to be updated or the amount of raw material to be provided by the transportation vehicle 106 to plant 101 (e.g., plant 101A) that needs an additional amount of the raw material to realize the production rate for the product (e.g., lithium-ion battery packs) is not to be altered, then, in operation 604, raw material distributor analyzer 207 of raw material distributor system 102 does not update the route or alter the amount of raw material to be provided by transportation vehicle 106.

Additionally, raw material distributor analyzer 207 receives feedback from production rate engine 202 when there is a change in the predicted production rate, such as a result to changes in the workflow. Such a change may result in updating the route or altering the amount of raw material to be provided by transportation vehicle 106 to plant 101 (e.g., plant 101A) needing an additional amount of raw material to realize the production rate for a product (e.g., food additive) as discussed below in connection with FIG. 7.

FIG. 7 is a flowchart of a method 700 for updating the route or altering the amount of raw material to be transported in response to changes in the predicted production rate in accordance with an embodiment of the present disclosure.

Referring to FIG. 7, in conjunction with FIGS. 1-6, in operation 701, feedback engine 209 of raw material distributor system 102 determines if there is any change in the predicted production rate.

As discussed above, in one embodiment, feedback engine 209 receives feedback from production rate engine 202 when there is a change in the predicted production rate, such as a result to changes in the workflow. For example, a new workflow may be generated by workflow generator 201 based on receiving new information from IoT sensors 105, which results in altering the workflow previously generated by workflow generator 201. Based on the changes to the workflow, production rate engine 202 may generate a new predicted production rate.

If there is no change in the predicted production rate, then feedback engine 209 continues to determine if there is any change in the predicted production rate.

If, however, there is a change in the predicted production rate, then, in operation 702, raw material distributor analyzer 207 of raw material distributor system 102 determines whether the selected route is to be updated or the amount of raw material to be provided by transportation vehicle 106 to plant 101 (e.g., plant 101A) that needs an additional amount of the raw material to realize the production rate for the product (e.g., lithium-ion battery packs) needs to be altered based on the new predicted production rate.

As stated above, based on the new predicted production rate, a new analysis will be performed by raw material estimator engine 203, inventory carrying cost analyzer 205, transportation cost analyzer 206 and route simulator 208 so that raw material distributor analyzer 207 can determine if the route needs to be updated or to alter the amount of the raw material (e.g., lithium) to be provided by the particular transportation vehicle 106 as previously discussed.

If the selected route is to be updated or the amount of raw material to be provided by transportation vehicle 106 to plant 101 (e.g., plant 101A) that needs an additional amount of the raw material to realize the production rate for the product (e.g., lithium-ion battery packs) is to be altered, then, in operation 703, raw material distributor analyzer 207 of raw material distributor system 102 updates the route or alters the amount of raw material (e.g., biomass) to be provided to plant 101 (e.g., plant 101A) by transportation vehicle 106.

As stated above, in one embodiment, the feedback information provided by IoT sensors 105 is utilized by raw material distributor analyzer 207 to determine if the route needs to be updated or to alter the amount of the raw material (e.g., lithium) to be provided by the particular transportation vehicle 106. In one embodiment, the analysis discussed above regarding minimizing the system inventory carrying cost and minimizing the system transportation cost is performed with such updated information, such as an updated predicted production rate. As a result of the updated predicted production rate, raw material estimator engine 203 updates the amount of raw material required by plant 101 to produce the product over a time frame based on the updated predicted production rate for the product at plant 101. Based on the updated amount of raw material required by plant 101, a new determination is made by raw material distributor analyzer 207 as to whether plant 101 needs additional raw material (e.g., biomass) to realize the production rate for the product (e.g., food additive). If plant 101 needs additional raw material to realize the production rate for the product, a new analysis will need to be performed by inventory carrying cost analyzer 205 to determine the inventory carry cost for each of these plants 101 with an excess amount of the raw material needed by plant 101 in question to realize its production rate for the product. Additionally, a new analysis will need to be performed by transportation cost analyzer 206 to determine the transportation cost for transporting the selected amount of raw material to be transported from one of the plants 101 (e.g., plant 101B) to the plant 101 (e.g., plant 101A) needing additional raw material to realize its production rate for the product. Furthermore, a new analysis will need to be performed by route simulator 208 to simulate the various routes from various transportation vehicles 106 transporting a selected amount of raw material from the various plants 101 that need to supply the needed raw material to the plant 101 (e.g., plant 101A) needing additional raw material to realize its production rate for the product. Based on such analysis as discussed above, raw material distributor analyzer 207 determines if the route needs to be updated or to alter the amount of the raw material (e.g., lithium) to be provided by the particular transportation vehicle 106. If the route needs to be updated or the amount of the raw material to be provided by the particular transportation vehicle 106 needs to be altered, raw material distributor analyzer 207 proceeds with updating the route or altering the amount of the raw material to be provided by the particular transportation vehicle 106.

If, however, the selected route is not to be updated or the amount of raw material to be provided by transportation vehicle 106 to plant 101 (e.g., plant 101A) that needs an additional amount of the raw material to realize the production rate for the product (e.g., lithium-ion battery packs) is not to be altered, then, in operation 704, raw material distributor analyzer 207 of raw material distributor system 102 does not update the route or alter the amount of raw material to be provided by transportation vehicle 106.

As a result of the foregoing, embodiments of the present disclosure provide a means for meeting the organization's plant capacity needs by ensuring that a plant has the required amount of raw material to realize its production rate for a product while minimizing the system inventory carrying cost and minimizing the system transportation cost.

Furthermore, the principles of the present disclosure improve the technology or technical field involving capacity planning software. As discussed above, capacity planning software is a programmable solution that helps manufacturing organizations understand the actual production capacity needed to address fluctuating demands for its products and services. Furthermore, capacity planning software helps companies compare production loads with available capacity within a specific time frame. The process of planning for capacity helps avoid bottlenecks in production which can impact the entire supply chain. Organizations may utilize multiple manufacturing plants to manufacture a product. A manufacturing plant (also referred to as a “production plant” or simply a “plant”) is an industrial facility, often a complex consisting of several buildings filled with machinery, whose workers manufacture items or operate machines which process each item into another. Such plants, at times, may have excess or a shortage amount of raw materials that are required in the production process. A raw material, also known as a feedstock, unprocessed material, or primary commodity, is a basic material that is used to produce goods, finished goods, energy, or intermediate materials that are feedstock for future finished products. A raw material is a material in an unprocessed or minimally processed state, such as raw latex, crude oil, cotton, coal, raw biomass, iron ore, air, logs, water or any product of agriculture, forestry, fishing or mineral in its natural form or which has undergone the transformation required to prepare it for marketing in substantial volumes. When plants have an excess or a shortage amount of raw materials, capacity planning software may utilize such information in an attempt to ensure that each plant in the organization has an adequate amount of raw materials to produce the required amount of products. Unfortunately, such capacity planning software tools fail to ensure that each plant in the organization has the required minimum amount of raw materials needed to produce the required amount of products while minimizing the organization's inventory carrying cost. “Inventory carrying cost,” as used herein, refers to the expenses that arise from keeping raw materials at the plant, such as being shelved at the plant. Neither do such software tools consider transportation cost, such as the cost for distributing the raw materials to the various plants, including from one plant to another plant. As a result, such capacity planning tools are deficient in meeting the organization's plant capacity needs while minimizing cost, such as the organization's inventory carrying cost and the organization's transportation cost.

Embodiments of the present disclosure improve such technology by creating a workflow of manufacturing a product using various machines at each plant of an organization, where the workflow illustrates which machines are utilized to produce the product using one or more raw materials. In one embodiment, such a workflow is based on feedback received from Internet of Things (IoT) sensors monitoring the raw material (e.g., lumber) that is used to manufacture a product (e.g., table) using a series of machines (e.g., single multi-purpose machine that is able to joint, plane and edge in a single pass, table saw, computer numerical control (CNC) router, sander and finishing booth). A production rate for the product at each plant of the organization manufacturing the product is predicted based on the workflow, where the production rate corresponds to a volume of units of the product to be manufactured during a time frame. An amount of a first raw material (e.g., biomass) required by a first plant to produce the product (e.g., food additive) is determined based on the predicted production rate for the product at the first plant. An amount of the first raw material is then routed to the first plant from one or more other plants based on minimizing the system inventory carrying cost and minimizing the system transportation cost if the first plant needs an additional amount of the first raw material to realize the predicted production rate for the product. In this manner, the organization's plant capacity needs are met by ensuring that a plant has the required amount of raw material to realize its production rate for a product while minimizing the system inventory carrying cost and minimizing the system transportation cost. Furthermore, in this manner, there is an improvement in the technical field involving capacity planning software.

The technical solution provided by the present disclosure cannot be performed in the human mind or by a human using a pen and paper. That is, the technical solution provided by the present disclosure could not be accomplished in the human mind or by a human using a pen and paper in any reasonable amount of time and with any reasonable expectation of accuracy without the use of a computer.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A system, comprising:
a memory for storing a computer program for efficient resource utilization using capacity planning; and
a processor connected to said memory, wherein said processor is configured to execute program instructions of the computer program comprising:
creating a workflow of manufacturing a product using various machines at each plant of an organization, wherein said workflow illustrates which machines are utilized to produce said product using one or more raw materials;
predicting a production rate for said product at each plant of said organization manufacturing said product based on said workflow, wherein said production rate corresponds to a volume of units of said product to be manufactured during a time frame;
determining an amount of a first raw material required by a first plant to produce said product over said time frame based on a first predicted production rate for said product at said first plant; and
routing an amount of said first raw material to said first plant from one or more other plants based on minimizing system inventory carrying cost and minimizing system transportation cost in response to said first plant needing an additional amount of said first raw material to realize said first predicted production rate for said product.

2. The system as recited in claim 1, wherein the program instructions of the computer program further comprise:
computing an inventory carrying cost for a second plant in response to said second plant having an excess amount of said first raw material needed to realize a second predicted production rate for said product by said second plant.

3. The system as recited in claim 1, wherein the program instructions of the computer program further comprise:
determining an inventory carrying cost for each plant of said organization with an excess amount of said first raw material needed to realize its predicted production rate for one or more products; and
determining said system inventory carrying cost based on said inventory carrying cost for each plant of said organization with said excess amount of said first raw material needed to realize its predicted production rate for one or more products.

4. The system as recited in claim 3, wherein the program instructions of the computer program further comprise:
selecting an amount of said first raw material to be provided from a second plant to said first plant based on minimizing said system inventory carrying cost.

5. The system as recited in claim 4, wherein the program instructions of the computer program further comprise:
determining a transportation cost for each of a plurality of simulated routes carrying said selected amount of said first raw material from said second plant to said first plant; and
selecting a route out of said plurality of simulated routes to transport said selected amount of said first raw material from said second plant to said first plant by a transportation vehicle with a minimum transportation cost.

6. The system as recited in claim 5, wherein the program instructions of the computer program further comprise:
receiving feedback from Internet of Things (IoT) sensors regarding current weather conditions, road conditions, vehicle conditions and route details.

7. A computer-implemented method for efficient resource utilization using capacity planning, the method comprising:
creating a workflow of manufacturing a product using various machines at each plant of an organization, wherein said workflow illustrates which machines are utilized to produce said product using one or more raw materials;
predicting a production rate for said product at each plant of said organization manufacturing said product based on said workflow, wherein said production rate corresponds to a volume of units of said product to be manufactured during a time frame;
determining an amount of a first raw material required by a first plant to produce said product over said time frame based on a first predicted production rate for said product at said first plant; and
routing an amount of said first raw material to said first plant from one or more other plants based on minimizing system inventory carrying cost and minimizing system transportation cost in response to said first plant needing an additional amount of said first raw material to realize said first predicted production rate for said product.

8. The method as recited in claim 7 further comprising:
computing an inventory carrying cost for a second plant in response to said second plant having an excess amount of said first raw material needed to realize a second predicted production rate for said product by said second plant.

9. The method as recited in claim 7 further comprising:
determining an inventory carrying cost for each plant of said organization with an excess amount of said first raw material needed to realize its predicted production rate for one or more products; and
determining said system inventory carrying cost based on said inventory carrying cost for each plant of said organization with said excess amount of said first raw material needed to realize its predicted production rate for one or more products.

10. The method as recited in claim 9 further comprising:
selecting an amount of said first raw material to be provided from a second plant to said first plant based on minimizing said system inventory carrying cost.

11. The method as recited in claim 10 further comprising:
determining a transportation cost for each of a plurality of simulated routes carrying said selected amount of said first raw material from said second plant to said first plant; and
selecting a route out of said plurality of simulated routes to transport said selected amount of said first raw material from said second plant to said first plant by a transportation vehicle with a minimum transportation cost.

12. The method as recited in claim 11 further comprising:
receiving feedback from Internet of Things (IoT) sensors regarding current weather conditions, road conditions, vehicle conditions and route details.

13. The method as recited in claim 12 further comprising:
updating said selected route or altering an amount of said first raw material to be provided by said transportation vehicle based on said feedback.

14. A computer program product for efficient resource utilization using capacity planning, the computer program product comprising one or more computer readable storage mediums having program code embodied therewith, the program code comprising programming instructions for:
creating a workflow of manufacturing a product using various machines at each plant of an organization, wherein said workflow illustrates which machines are utilized to produce said product using one or more raw materials;
predicting a production rate for said product at each plant of said organization manufacturing said product based on said workflow, wherein said production rate corresponds to a volume of units of said product to be manufactured during a time frame;
determining an amount of a first raw material required by a first plant to produce said product over said time frame based on a first predicted production rate for said product at said first plant; and
routing an amount of said first raw material to said first plant from one or more other plants based on minimizing system inventory carrying cost and minimizing system transportation cost in response to said first plant needing an additional amount of said first raw material to realize said first predicted production rate for said product.

15. The computer program product as recited in claim 14, wherein the program code further comprises the programming instructions for:
computing an inventory carrying cost for a second plant in response to said second plant having an excess amount of said first raw material needed to realize a second predicted production rate for said product by said second plant.

16. The computer program product as recited in claim 14, wherein the program code further comprises the programming instructions for:
determining an inventory carrying cost for each plant of said organization with an excess amount of said first raw material needed to realize its predicted production rate for one or more products; and
determining said system inventory carrying cost based on said inventory carrying cost for each plant of said organization with said excess amount of said first raw material needed to realize its predicted production rate for one or more products.

17. The computer program product as recited in claim 16, wherein the program code further comprises the programming instructions for:
selecting an amount of said first raw material to be provided from a second plant to said first plant based on minimizing said system inventory carrying cost.

18. The computer program product as recited in claim 17, wherein the program code further comprises the programming instructions for:
determining a transportation cost for each of a plurality of simulated routes carrying said selected amount of said first raw material from said second plant to said first plant; and
selecting a route out of said plurality of simulated routes to transport said selected amount of said first raw material from said second plant to said first plant by a transportation vehicle with a minimum transportation cost.

19. The computer program product as recited in claim 18, wherein the program code further comprises the programming instructions for:
receiving feedback from Internet of Things (IoT) sensors regarding current weather conditions, road conditions, vehicle conditions and route details.

20. The computer program product as recited in claim 19, wherein the program code further comprises the programming instructions for:
updating said selected route or altering an amount of said first raw material to be provided by said transportation vehicle based on said feedback.
